(19) United States
(12) Patent Application Publication
(10) Pub. No.: US 2012/0021390 A1
(43) Pub. Date: Jan. 26, 2012

(54) Method and system for developing language and speech

(76) Inventor: Enda Patrick Dodd, Santa Rosa, CA (US)

(21) Appl. No.: 13/136,188

(22) Filed: Jul. 26, 2011

Related U.S. Application Data
(63) Continuation-in-part of application No. PCT/EP2010/051201, filed on Feb. 1, 2010.
(60) Provisional application No. 61/148,932, filed on Jan. 31, 2009.

(51) Int. Cl. G09B 19/00

(52) U.S. Cl. 434/185

(57) ABSTRACT

A method, system and apparatus for developing concepts, language and speech in language learning disabled and generally learning disabled subjects. The approach attempts to build associations between the various implementations of language, namely, visual, oral, aural and written language within the subject. The technique utilizes the subject's main strengths, often the visual sense and develops language by building on that strength, gradually progressing to spoken and heard language. Graphically rich content is sued to convey the concepts to the subject. The disclosed techniques may be implemented using a computer program.

This application is a continuation-in-part of PCT/EP2010/051201, filed Feb. 1, 2010, which claims priority to U.S. Provisional Application Ser. No. 61/148,932, filed Jan. 31, 2009, the disclosures of which are herein incorporated by reference.

### BACKGROUND OF THE INVENTION

1. Field of the Invention

This invention relates generally to a method and system for developing language and speech in language learning disabled (LLD), language learning impaired (LLI) and generally learning disabled (LD) human subjects.

2. Description of the Related Art

Communication disorders are among the most common disabilities in school-going children worldwide. Market research and healthcare statistics estimate that the number of children afflicted by communication disorders in the United States are in the region of 5 million children as of 2011 or 10% of the child population. Similar rates of incidence of these disorders are also known to present in Europe and Japan. Approximately 10% of the total population will meet the diagnostic criteria for autistic spectrum disorder (ASD) or pervasive development disorder (PDD). Communication disorders and related conditions therefore represent a serious issue around the world for children, their families and caregivers.

A child's overall future and success can be improved greatly through the early identification of communication disorders establishment of their causes and subsequent intervention. In its more severe forms, including ASD, fundamental language development issues in children can result in severe life-long learning handicaps. These handicaps lead to isolation and learning disruption which affect not only the child, but the nuclear family and care givers who struggle to find solutions to the impacts of the disorder. In the United States, Europe and Japan some 12 million children suffer from various forms of communication disorders.

More severe forms of language disorders including ASD and PDD are estimated to afflict in the range of 1.6 million children in these geographies. Children presenting with ASD or PDD diagnosis frequently see highly restrictive, isolating clinical and educational settings based on extremely specialized and expensive intervention modalities such as Language pathology, Applied Behavioral Analysis (ABA), Treatment and Education of Autistic and Communication related handicapped Children (TEACCH) supported by sensory integration strategies. The United States National Institutes of Health estimate that an 800% increase in the diagnosis of Autism and related development disorders in children has occurred over the last 10 years. Arising from this, these disabilities represent one of this generation's greatest healthcare and educational challenges. The disorder manifests as a developmental disruption of communication skills in children. This coupled with the emergence of often severe behavioral and social deficits leads to a greatly reduced capacity of the child to access a full and independent life.

Autism prevalence is increasing at epidemic rates. In the last ten years, there has been an 800% increase in the number of diagnoses of Autism in the United States. A recent US study indicated a 1 in 91 prevalence of communication disorders among United States children aged 3-17. While growth in the less severe language disorders is believed to follow population demographics, the more severe autistic spectrum disorders are growing disproportionately. The genesis of the condition is not understood, but is believed to have genetic origins. At this time there is no known cure for the condition. Clinical, educational and custodial costs associated with children manifesting this condition are conservatively estimated to exceed $35 billion annually in the US alone. Despite intense debate among key opinion leaders providing therapies, long term outcomes remain generally poor among the moderate to severely impacted school-going children. In the case of less severe conditions, access to clinical specialists and an ability to fund high levels of private practitioner intervention are critical to improved long term outcomes.

Various methods and products have been devised to help those with language learning disabilities and general learning disabilities to develop communication skills. One such product is that described in European Patent No. EP 0 963 583 in the name of Scientific Learning Corp. As described, this invention and the majority of the current methods and products in this arena focus on orally delivered therapies. Unfortunately these approaches have not succeeded in delivering consistent, clinically meaningful results except in relatively small subsets of the overall clinical population.

One of the most significant problems associated with these syndromes is the absence of a fundamental understanding of concepts, which in turn can be abstractly labeled by “language”. Speech and hearing, reading and writing, are the primary modalities of inter-personal communication arising from this language. Children initially learn concepts concretely (or directly) from their environments. In the early months of life, a broadly balanced use of all senses enable this learning, although sight and sound become increasingly dominant over time. As an example, the concept of “mom” for a child is a collage of multi-sensory experiences of sight, sound, taste, smell, touch and so on. As time progresses, parents label these concepts with words (in this case “mom”) annunciated through speech. It is through this process of auditory stimulus and labeling that language emerges from concepts. Later on, the child will be taught reading and writing to supplement the already established auditory (spoken) system of language.

In the case of children presenting with communication disorders, frequently the process of environmental learning is confused, leading to a related and resulting disruption of concept development and associated labeling. In this way, language fails to emerge naturally. As time goes on, isolation, fear and frustration associated with the condition leads the child to disengage from care givers (often termed “poor eye contact”) further exasperating the clinical symptoms.

From the child's perspective, the world and people pervading are unpredictable and confusing. The child perceives a profound lack of control even in terms of their most basic needs. Inter-personal interaction, with all its socio-emotional nuances is most confusing given the vast and complex nature of human communication. This results in a negative spiral of increasing isolation, frustration and fear with attending physical behaviors. In this state, impacted children are frequently described as “unreachable and unteachable” even by their closest caregivers including parents and recede into an inward and isolated world.

Current interventions to remediate these deficits, as noted above, primarily include highly specialized clinical language pathology coupled with related educational practices and auditory based software programs. Beyond being costly, these practices suffer from three major disadvantages. First of all, there is an inability to create and maintain consistent engagement of the child to the treating practitioner which is the basis of, and critical to all learning. Secondly, the methods employ or substantially depend on the disordered and abstract auditory sense as a learning conduit which is often impractical. Thirdly, the current approaches are ineffective in the development of broadly based concepts in the target children to which language is to be applied, leading to limited and incomplete understanding.

In essence therefore, current language development practice primarily stimulates the child with abstract, often auditory (verbal) language in an attempt to label concepts which have not in themselves been effectively established in the child.

In summary therefore, the prior art methods are substantially limited to addressing auditory related delays, disorders or impairments primarily as a means to improving child receptivity to language terms (i.e. words or structure) without addressing the primary need of conceptual understanding. All approaches require substantial delivery and control by Adult care givers, introducing complex and unpredictable (from the child's perspective) stimuli while removing control of the language learning process from the child. These interventions have very limited success with the ASD patient population and do not adequately address the needs of the wider language learning impairment populations.

### SUMMARY OF THE INVENTION

It is an object of the present invention to provide a method and product that overcomes these difficulties with the known offerings. This is achieved through an number of fundamental innovations which resolves the established issues noted in the introduction above. The method and product stimulates the child with rich visual media which establishes a fundamental understanding of the concept to which language is to be applied. An engaging, structured and sequential process of language investigation is presented to and acted upon by the child thereby rapidly establishing an interactive, text based communication between the child and invention.

Once the invention has been demonstrated to the child, it does not require human intervention for the child to engage in the invention's language development process. The invention is controlled by the child without other human intervention and, by virtue of its technology and embedded process is self-sustaining much as in the case of popular video games.

As the invention established literacy in the child, that is reading and writing, the foundations are laid to elicit auditory listening skills and the production of speech. The child directed and controlled invention provides highly focused concept and language development stimuli in a predictable and structured manner. This symbiotic interaction between child and invention obviates the anxiety, frustration and resulting lack of engagement pervasive in currently available offerings.

According to the invention there is provided a computer implemented method of developing language and speech in language learning disabled (LLD) language learning impaired (LLI) and generally learning disabled (LD) human subjects, the computer comprising a processor, a memory, a visual display unit (VDU), an audio output device, an audio input device and a user input device, the method comprising the steps of: selecting a concept to teach to the human subject; displaying a video clip demonstrative of the concept to the subject on the VDU; displaying a still image demonstrative of the concept taken from the video clip to the subject on the VDU; displaying a plurality of words along with the still image to the subject on the VDU, one of the words being descriptive of the concept demonstrated by the still image and one or more words being a decoy word that is non-descriptive of the concept; for each of the words, providing a library of word images in memory that are demonstrative of the word; retrieving one or more word images from the library and displaying the one or more retrieved word images on the VDU upon request by the human subject for comparison with the still image; and receiving an input from the human subject pairing one of the words with the still image.

In one embodiment of the invention the method comprises the additional step of providing a video clip of the word that is descriptive of the concept being taught, the video clip of the word comprising a visual demonstration of the word being orally expressed.

In one embodiment of the invention the method comprises the additional steps of: capturing a video of the human subject attempting to emulate the oral expressions in the visual demonstration of the word being orally expressed; and playing back the video of the human subject attempting to emulate the oral expressions on the VDU. In one embodiment of the invention the video of the human subject attempting to emulate the oral expressions is played back on the VDU coincidentally with the video clip of the word being orally expressed.

In one embodiment of the invention the method comprises the additional steps of: displaying a video of a word that is descriptive of the concept being taught, the video of the word comprising a visual demonstration of the word being orally expressed; displaying a plurality of word selections in text, one of which is the word being spoken and the other being a decoy word; and receiving an input from the human subject pairing one of the text words with the video of the word being orally expressed.

In one embodiment of the invention the method comprises the steps of: for each of the word selections in text, providing a library of videos with audio content in memory that are demonstrative of the word; retrieving one or more videos with audio content from the library and displaying the one or more retrieved videos on the VDU upon request by the human subject for comparison with the video of the word being orally expressed.

In one embodiment of the invention the library of videos comprise a single character expressing words corresponding to the selection of words provided. In one embodiment of the invention the library of videos comprise a plurality of characters expressing each of the word selections.

In one embodiment of the invention the method comprises the steps of: displaying a still image demonstrative of the concept to be taught to the subject on the VDU; displaying a plurality of words along with the still image to the subject on the VDU, one of the words being descriptive of the concept demonstrated by the still image and one or more words being a decoy word that is non-descriptive of the concept; receiving an oral response from the human subject matching one of the displayed words to the still image.

In one embodiment of the invention the method comprises the additional steps of: playing a stimulus audio file; providing a plurality of still images, each having an audio file associated therewith, one of which corresponds to the stimulus audio file; and receiving an input from the human subject pairing one of the still images and its corresponding audio file with the stimulus audio file.

In one embodiment of the invention the step of playing a stimulus audio file comprises playing a soundtrack. In another embodiment of the invention the step of playing a stimulus audio file comprises playing a tone. In a further embodiment of the invention the step of playing a stimulus audio file comprises playing an auditory complex.

In one embodiment of the invention the step of playing an auditory complex comprises playing a phonemic or other word building block sound. In one embodiment of the invention the library of word images comprise still images. In one embodiment of the invention the library of word images comprise video clips. According to one aspect of the invention there is provided a computer program product comprising a computer usable medium having computer readable program code embodied therein, said computer program code adapted to be executed to implement a method of developing language and speech in language learning disabled (LLD) language learning impaired (LLI) and generally learning disabled (LD) human subjects, the method comprising the steps of: selecting a concept to teach to the human subject; displaying a video clip demonstrative of the concept to the subject; displaying a still image demonstrative of the concept taken from the video clip to the subject; displaying a plurality of words along with the still image to the subject, one of the words being descriptive of the concept demonstrated by the still image and one or more words being a decoy word that is non-descriptive of the concept; for each of the words, providing a library of word images that are demonstrative of the word; retrieving one or more word images from the library and displaying the one or more retrieved word images upon request by the human subject for comparison with the still image; and receiving an input from the human subject pairing one of the words with the still image.

In one embodiment of the invention the method comprises the additional step of providing a video clip of the word that is descriptive of the concept being taught, the video clip of the word comprising a visual demonstration of the word being orally expressed.

In one embodiment of the invention the method comprises the additional steps of: capturing a video of the human subject attempting to emulate the oral expressions in the visual demonstration of the word being orally expressed; and playing back the video of the human subject attempting to emulate the oral expressions. In one embodiment of the invention the video of the human subject attempting to emulate the oral expressions is played back coincidentally with the video clip of the word being orally expressed.

In one embodiment of the invention the method comprises the additional steps of: displaying a video of a word that is descriptive of the concept being taught, the video of the word comprising a visual demonstration of the word being orally expressed; displaying a plurality of word selections in text, one of which is the word being spoken and the other being a decoy word; and receiving an input from the human subject pairing one of the text words with the video of the word being orally expressed.

In one embodiment of the invention the method comprises the steps of: for each of the word selections in text, providing a library of videos with audio content that are demonstrative of the word; retrieving one or more videos with audio content from the library and displaying the one or more retrieved videos upon request by the human subject for comparison with the video of the word being orally expressed. In one embodiment of the invention the library of videos comprise a single character expressing words corresponding to the selection of words provided.

In one embodiment of the invention the library of videos comprise a plurality of characters expressing each of the word selections.

In one embodiment of the invention the method comprises the steps of: displaying a still image demonstrative of the concept to be taught to the subject; displaying a plurality of words along with the still image to the subject, one of the words being descriptive of the concept demonstrated by the still image and one or more words being a decoy word that is non-descriptive of the concept; receiving an oral response from the human subject matching one of the displayed words to the still image.

In one embodiment of the invention the method comprises the additional steps of: playing a stimulus audio file: providing a plurality of still images, each having an audio file associated therewith, one of which corresponds to the stimulus audio file; and receiving an input from the human subject pairing one of the still images and its corresponding audio file with the stimulus audio file.

In one embodiment of the invention the step of playing a stimulus audio file comprises playing a soundtrack. In another embodiment of the invention the step of playing a stimulus audio file comprises playing a tone. In a further embodiment of the invention the step of playing a stimulus audio file comprises playing an auditory complex.

In one embodiment of the invention the step of playing an auditory complex comprises playing a phonemic or other word building block sound.

In one embodiment of the invention the library of word images comprise still images.

In one embodiment of the invention the library of word images comprise video clips. According to one aspect of the invention there is provided a method of developing language and speech in language learning disabled and generally learning disabled human subjects comprising the steps of: providing a representation of the concept to be taught in a first format; providing a plurality of representations in a second format, one of the which being an alternative representation of the concept to be taught; and causing the human subject to determine an association between the representation in the first format of the concept to be taught and the alternative representation in the second format of the concept to be taught.

In one embodiment of the invention the human subject determines the association between the representation of the concept to be taught in the first format and the second format by: accessing a library of representations associated with the representation in the second format, the library containing a plurality of representations in the first format; comparing the representations in the first format in the library with the representation of the concept in the first format; determining whether the representations in the library are equivalent to the representation of the concept in the first format and thereby determining an association between the representation of the concept to be taught in the first format and the second format.

In one embodiment of the invention the representation of the concept to be taught in a first format is provided in a still image format.

In one embodiment of the invention the representation of the concept to be taught in a first format is provided in a video format.

In one embodiment of the invention the representation of the concept to be taught in a first format is provided in an audio format.

In one embodiment of the invention the representation in the second format is provided in a text word format.

In one embodiment of the invention the representation in the second format is provided in a still image format.

In one embodiment of the invention a series of representations of the concept to be taught are provided in a plurality of different formats and the human subject forms associations with the series of representations of the concept to be taught. In one embodiment of the invention the series of representations of the concept to be taught become gradually more abstract, the first representation in the series being the most concrete representation of the concept to be taught and the last representation in the series being the most abstract.

In one embodiment of the invention the first representation in the series is (i) a video representation, which graduates in sequence to one or more of (ii) a pictorial representation; (iii) a text word representation; (iv) an oral language production representation; and (v) a receptive spoken language representation.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is an overview of the components of the methodology and product;

FIG. 2 is a diagrammatic representation of a first sub-system of the methodology and product;

FIG. 3 is a diagrammatic representation of a second sub-system of the methodology and product;

FIG. 4 is a diagrammatic representation of a third sub-system of the methodology and product;

FIG. 5 is a diagrammatic representation of a fourth sub-system of the methodology and product;

FIG. 6 is a diagrammatic representation of a fifth sub-system of the methodology and product;

FIG. 7(a) to FIGS. 7(p) inclusive are representations demonstrating the operation of the first sub-system of the methodology and product;

FIGS. 8(a) to 8(d) inclusive are diagrammatic representations demonstrating the operation of the second sub-system of the methodology and product;

FIGS. 9(a) to 9(d) inclusive are diagrammatic representations demonstrating the operation of the third sub-system of the methodology and product;

FIGS. 10(a) to 10(d) inclusive are diagrammatic representations demonstrating the operation of the fourth sub-system of the methodology and product; and

FIGS. 11(a) to 11(d) inclusive are diagrammatic representations demonstrating the operation of the fifth sub-system of the methodology and product.

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art. Any and all such modifications, equivalents and alternatives are intended to fall within the spirit and scope of the present invention.

This invention relates to a method and system for developing language and speech in language learning disabled (LLD), language learning impaired (LLI) and generally learning disabled (LD) human subjects. Conditions such as autistic spectrum disorder (ASD) and pervasive developmental disorder (PDD) will also benefit from the invention where language impairments present as substantial comorbidities to the primary diagnosis. Language delays, accelerated language learning and second language learning are also indicated as well as the treatment of adult aphasias. More specifically, this invention relates to a computer-implemented method and a computer program product with program instructions for implementing the method.

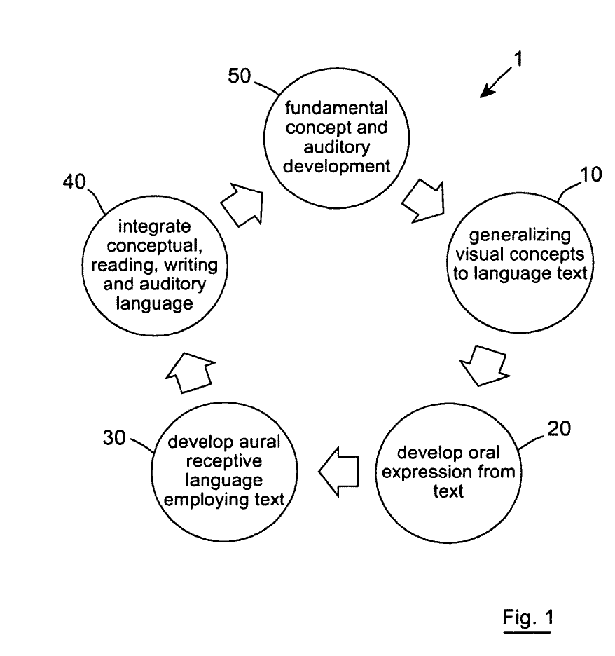

Referring to the drawings and initially to FIG. 1 thereof, there is shown a meta system indicated generally by the reference numeral 1. The meta system 1 comprises a plurality of sub-systems including a fundamental concept and auditory development sub-system 50, a generalizing visual concepts to language text sub-system 10, a developing oral expression from text sub-system 20, developing aural receptive language employing text sub-system 30 and an integrating conceptual, reading, writing and auditory language sub-system 40. The operation and features of each of the sub-systems will be described in greater detail below. When the present invention is embodied in a computer program, each of the sub-systems will be embodied as a component or module of that computer program forming part of the overall meta program.

The configuration of the system described below is for a severely disabled (Aphasic), visually dominant child, that is a child with severe auditory processing disorder (meaning functionally deaf), severe pragmatic, semantic and syntactic language disorder (meaning they cannot learn language) and globally apraxic (meaning they cannot control fine motor, muscle movement). The following description discusses an implementation of the invention for use with a subject having such characteristics. The system however can be defined in other configurations depending on the clinical diagnosis. In other words, depending on the precise clinical comorbidities that are present and prevailing relative strength(s), a suitable program can be tailored to suit the individual needs of the subject. Given less complex disorders certain steps may not be required and will be omitted from the process in addition to a reordering of the remaining steps. For example, a child with auditory dominance as opposed to visual dominance would likely enter the process at the develop aural receptive language employing text sub-system component 30 and the fundamental concept and auditory development sub-system 50 would be omitted.

Other combinations of disabilities may equally mandate a reordering of the process steps and the meta system demonstrates a modular system architecture that lends itself to this type of flexibility. It is further envisaged that the step 50 may, in addition to providing useful therapy, be used as the initial step in the process as a way of gauging the level of the subject and the appropriate treatment that is required for that subject and the number, order and complexity level of the remaining sub-systems 10, 20, 30, 40 may be chosen depending on the outcome of the analysis carried out using sub-system 50. Therefore, the diagrammatic representation of the meta system 1 shown in FIG. 1 may vary depending on differing clinical states coupled with the embedded fundamental deficits versus relative strengths of the subject.

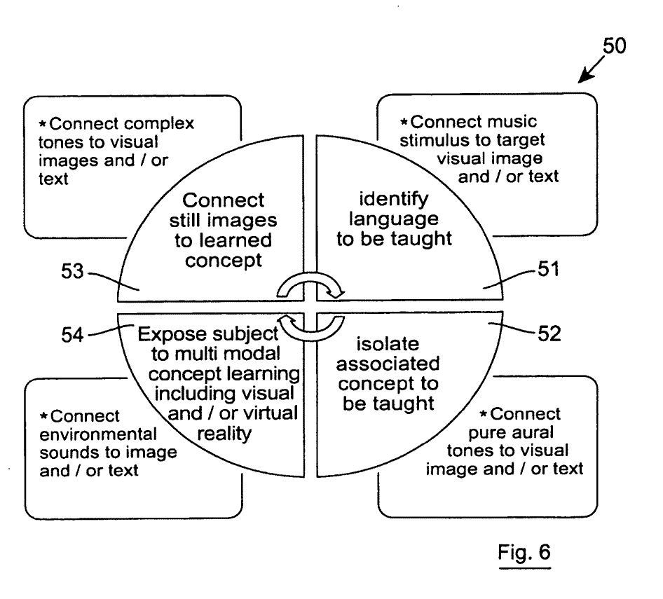

Referring to FIG. 6, there is shown a more detailed view of the fundamental concept and auditory development sub-system, indicated generally by the reference numeral 50. The sub-system 50 comprises an identify language to be taught component 51, an isolate associated concept to be taught component 52, an expose subject to multimodal concept learning including visual and/or virtual reality component 53 and a connect still images to learned concept component 54. The identify language to be taught component 51 connects music stimulus to target visual image and/or text. The isolate associated concept to be taught component 52 connects pure aural tones to visual image and/or text. The expose subject to multimodal concept learning including visual and/or virtual reality component 53 connects the environmental sounds to image and/or text and finally the connect still images to learned concept component 54 connects complex tones (for example, blended consonant vowel combinations) to visual images and/or text. Visual image may be defined as still or moving (example Computer Generated Image (CGI)) imagery.

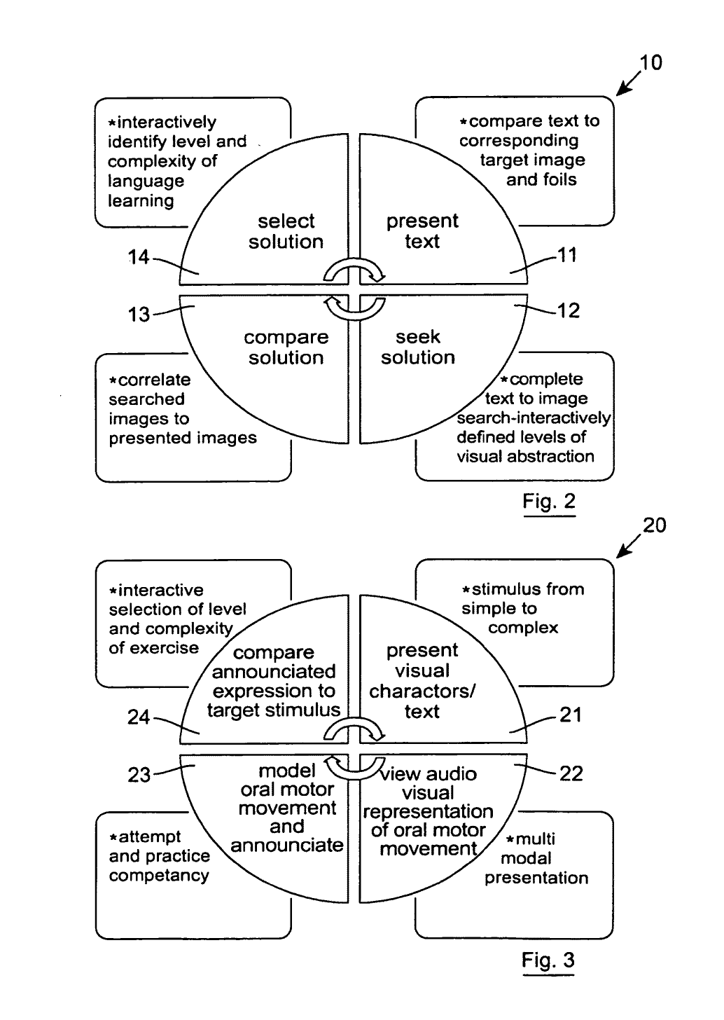

Referring to FIG. 2, there is shown a more detailed representation of the generalising visual concepts to language text sub-system 10. The sub-system 10 comprises four main components namely a present text component 11, a seek solution component 12, a compare solution component 13 and a select solution component 14. The present text component 11 presents a target image along with text and foil text to the human subject so that they may compare the target image to the text and the foil texts. The seek solution component 12 permits text to image searching by the human subject. The text to image search preferably has interactively defined levels of visual abstraction between the image and the text. The compare solution component 13 allows for the correlation of searched images to the presented images and finally the select solution component 14 permits interactive identification of the level and complexity of language learning required for the human subject once the correct or incorrect answer is provided. Again, the visual image may be defined as still or moving (for example, CGI) imagery.

Referring to FIG. 3, there is shown a more detailed view of the develop oral expression from text sub-system 20. The sub-system 20 comprises a present visual characters/text component 21, a view audio visual representation of oral motor movement component 22, a model oral motor movement and annunciate component 23 and a compare annunciated expression to target stimulus component 24. The present visual characters/text component 21 provides stimulus ranging from simple stimulus to more complex stimulus. In other words the character or representation making the visual representation of the word can have quite pronounced actions, or indeed the word itself may require quite pronounced actions and movement of the mouth, graduating upwards to more complex, subtle changes to the movements required. The view audio visual representation of oral motor movement component 22 allows for multi-modal presentation. In other words, it is possible to provide different video clips of the word being pronounced. The model oral motor movement and annunciate component 23 allows the human subject to attempt and practice their competency and essentially mimic (oral motor planning of) the mouth movements made by the character presenting the word. The compare annunciated expressions to target stimulus component 24 provides for interactive selection of level and complexity of exercise. Again, if the analysis of the human subject annunciating the word indicates that the annunciation is accurate, then more difficult words to annunciate may be presented to the human subject and likewise if the analysis indicates that the annunciation is relatively poor, more simple words can be presented to the human subject to allow them obtain further experience prior to graduating on to more difficult phrases.

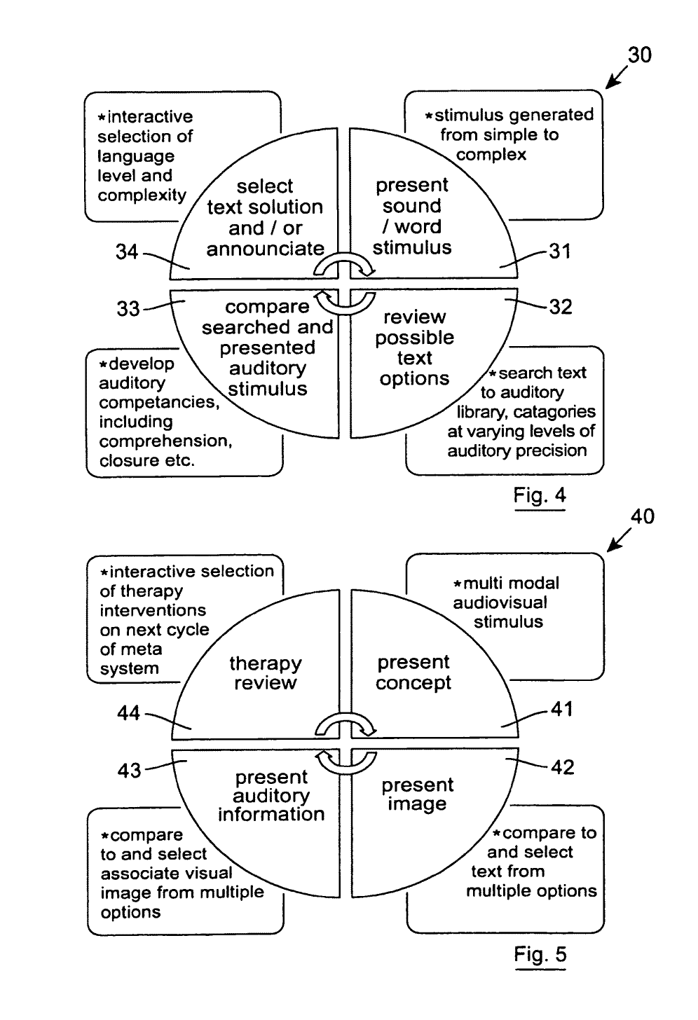

Referring to FIG. 4 of the drawings, there is shown a more detailed view of the develop aural receptive language employing text sub-system, indicated generally by the reference numeral 30. The sub-system 30 comprises a plurality of components namely a present sound/word stimulus component 31, a review possible text options component 32, a compare searched and presented auditory stimulus component 33 and finally a select text solution and/or annunciate component 34. The present sound/word stimulus component 31 allows for different levels stimulus to be generated from simple to complex. The review possible text options component 32 allows the individual to search a text to auditory library in categories of varying levels of auditory precision. The compare searched and presented auditory stimulus component 33 allows the individual to develop receptive auditory competencies including aural comprehension, word closure, word identification in a sentence and the like. The select text solution and/or annunciate allow the human subject to provide a response to the question or query posed and an interactive selection of language level and complexity.

Referring to FIG. 5 there is shown a more detailed view of the integrated conceptual, reading, writing and auditory language sub-system indicated generally by the reference numeral 40. The sub-system 40 comprises a present concept component 41, a present image component 42, a present auditory information component 43 and a therapy review component 44. The present concept component 41 provides for multi-modal audio visual stimulus, for example a video, a CGI clip, or other audio visual stimulus. The component 42 presents an image taken from the audio visual stimulus along with text with multiple options for the human subject. The subject is required to choose one of the text words and match it to the image in response to the question. In component 42 the human subject is allowed to compare and select associated visual images from multiple options. However, the system provides an auditory stimulus and the human subject must match the pictorial representation to the auditory stimulus. In component 44 there is provision for interactive selection of therapy interventions on the next cycle of the meta system based on the responses provided by the human subject. The system processes the responses from the previous steps and the development and conceptual expressive and receptive language is quantified by the system. The system then decides content of the next meta cycle including therapy steps in the cycle, the conceptual aspects, the associated language aspects, the level of subtleness of competing concepts and the level of concreteness of searchable libraries. The system is programmed with artificial intelligence features, thereby allowing the method to be tailored to specific performance of the subject. The system may be overridden if desired by an operator.

Each of the sub-systems has a particular developmental function. The sub-system 10 provides stimulus selection and association of multi-sensory concepts to a written language which mediates semantic and syntactic language deficits. The sub-system 20 ensures stimulus selection and association of written words to speech and oral motor movement to mediate speech production and pragmatic deficits. The sub-system 30 provides stimulus selection and association of speech and oral motor movement to written words to mediate auditory processing and/or hearing impairment deficits. The sub-system 40 comprises stimulus selection and association of speed to multi-sensory concepts to complete the concept and language therapy. The sub-system 50 provides stimulus selection in auditory to visual association to establish basic phoneme recognition (and other like word building blocks) and expression.

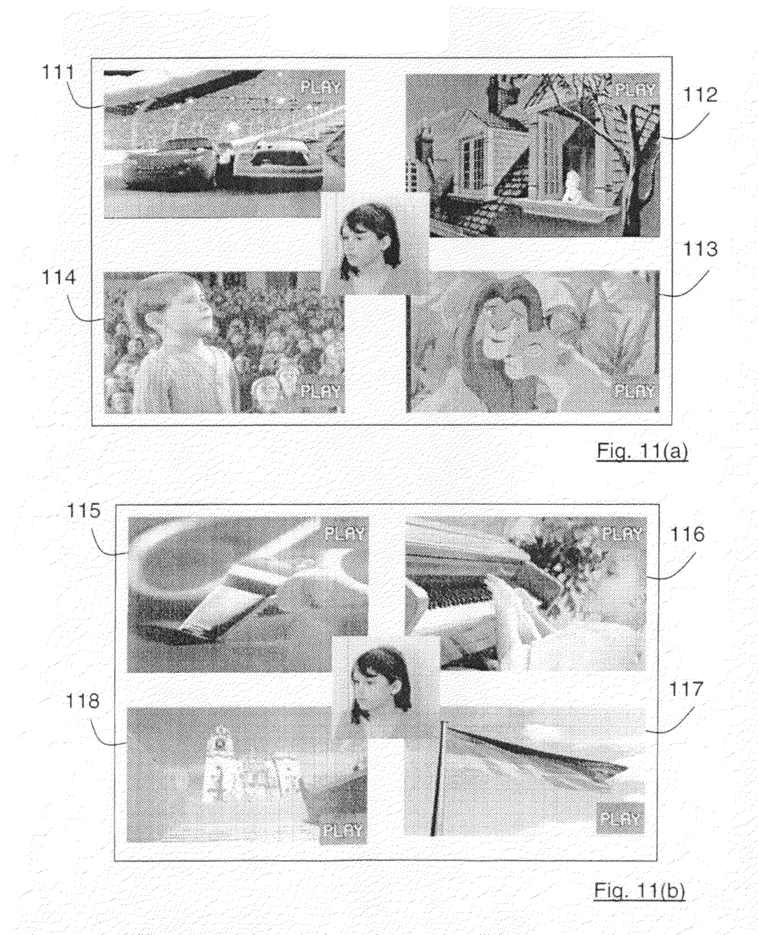

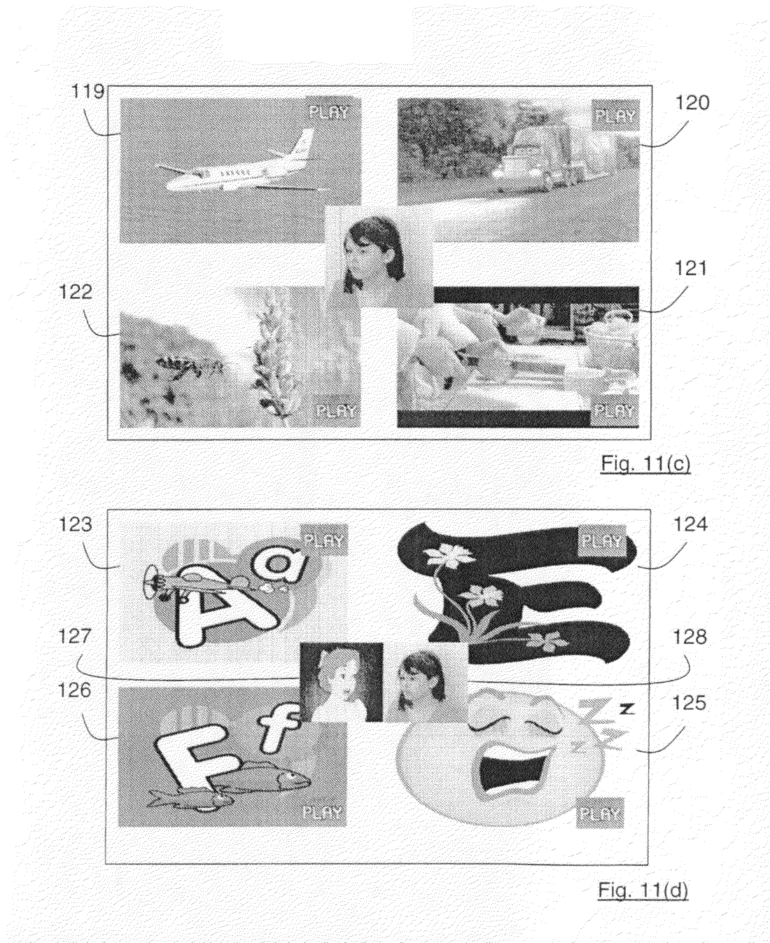

Referring to FIGS. 11(a) to 11(d) inclusive, there is shown a diagrammatic representation of the operation of the sub-system 50 of the methodology and product according to the invention. The sub-system 50 is concerned with the fundamental concept and auditory development. In FIG. 11(a), the system plays a stimulus soundtrack to the subject. At the same time a number of still images from videos 111, 112, 113 and 114 are displayed on the visual display unit (VDU). Each image 111-114 may be selected in the known manner to play the video and have its soundtrack played. The subject compares and selects the video and soundtrack to the stimulus soundtrack.

Referring now to FIG. 11(b) instead of a soundtrack, the system may play a stimulus tone. A number of tones are represented by pictorial images 115, 116, 117 and 118. Each image may be selected to play its associated tone and the human subject compares and selects the matching image and associated tone with the stimulus tone. In the embodiment shown, the tone may be a whistle blast (115), a piece of piano music (116), a flag flapping (117) or bells tolling in a cathedral 118.

It is possible to increase the difficulty level as may be seen with reference to FIG. 11(c) in which a stimulus auditory complex is played to the human subject. A plurality of images 119, 120, 121 and 122 are provided each with its own auditory complex (audio file) associated therewith. The subject compares and selects the matching image and its corresponding auditory complex to the stimulus auditory complex. In the embodiment shown the auditory complex may be an airplane in flight 119, a bee buzzing 122 over a sustained period of time, a truck moving along a road 120, or chefs working in a restaurant 121. In other words, there is a continuous multi component tone that is moderately complex (example contains harmonics) as opposed to a pure tone whistle as provided for in the example described with reference to FIG. 11(b).

Finally, it is possible to further increase the complexity of the task by playing a stimulus auditory complex and presenting images which are typically alpha-numeric images that may be clicked for their associated phonemic sound. The subject compares and selects the matching image/sound with the auditory complex which itself is a phonemic sound. A number of images 123, 124, 125 and 126 are presented to the human subject and they may select them, listen to the phonemic sounds associated therewith and build associations between the phonemic sound and the symbols. In the embodiment shown, a character 127 is provided and this character is used to mouth the phonemic sound, preferably as the corresponding audio file of the phonemic sound is played. The subject watches the character 127 and a live video stream of the subject 128 is played simultaneously so that they can see themselves mouth the word and compare their performance to the character. This aspect can also be used in a training mode whereby the phoneme symbols may be clicked and the character 127 will recite the phoneme allowing the subject to copy and monitor their performance relative the character. In this instance the stimulus is the text with supplementary auditory feedback from speech.

Once again, it can be seen that the sub-system may present gradually more challenging tasks for the subject. Generally speaking the audio soundtracks (FIG. 11(a)) will have a long cadence and beat and should be the simplest form of sound for the subject to recognize. The pure tones such as those demonstrated in FIG. 11(b) will be the next simplest audio components to detect. Finally, the auditory complex and the auditory complex of phonemes are the most difficult audio components for the subject to process. The video image tends to become gradually more simplistic whereas the audio component becomes gradually more complex.

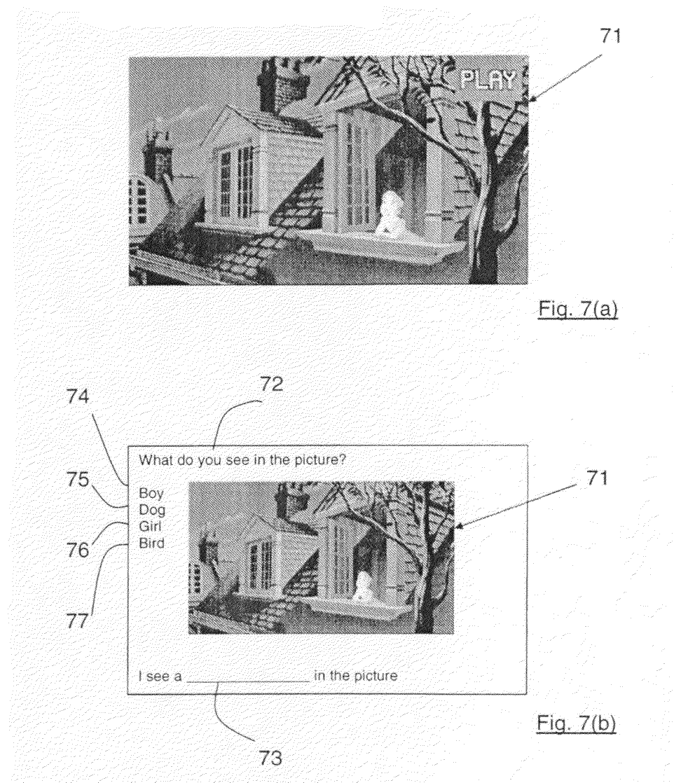

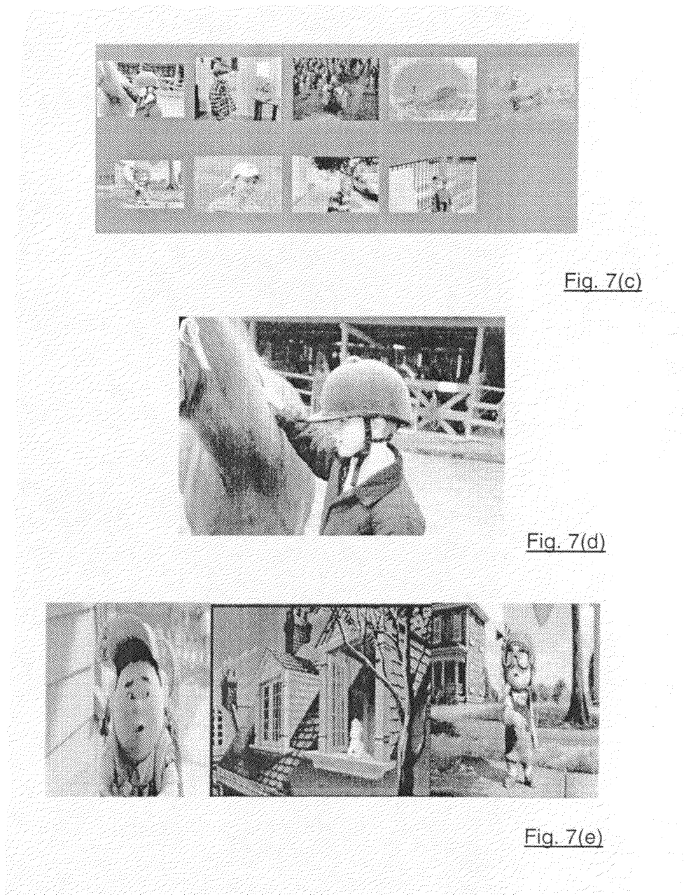

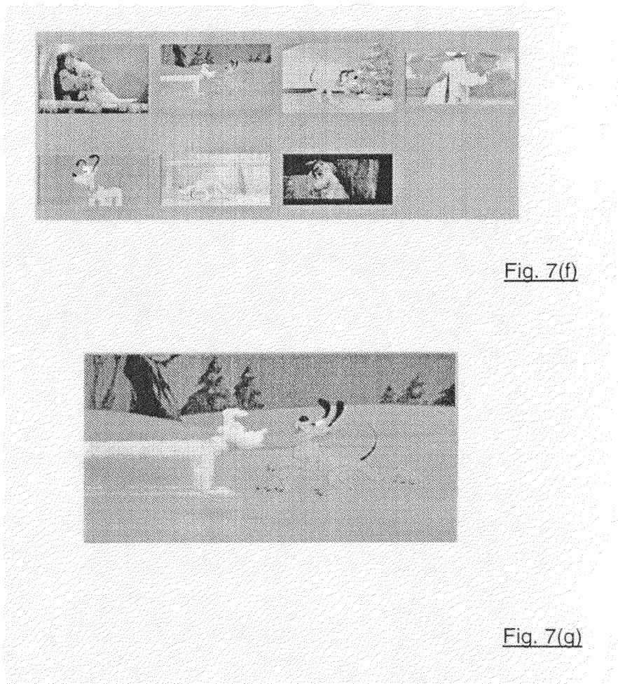

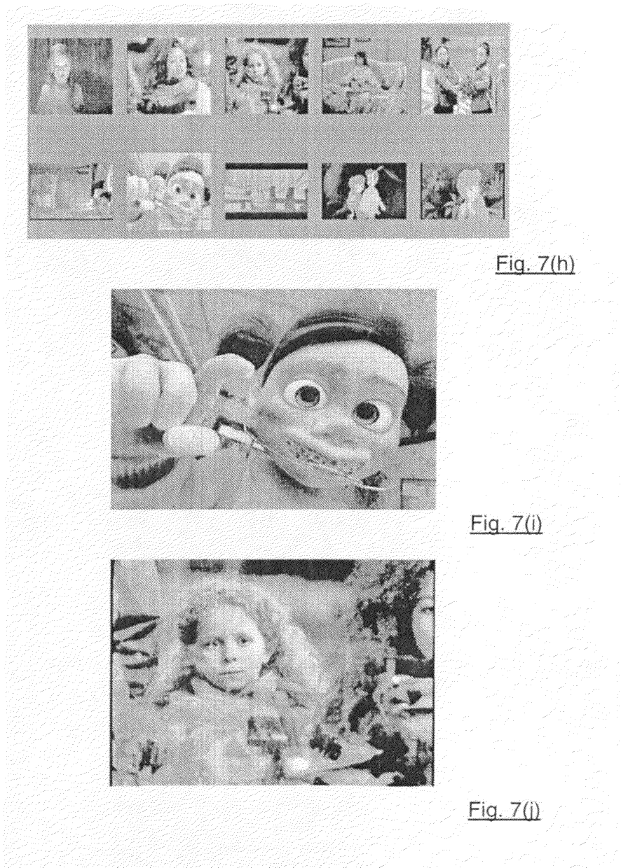

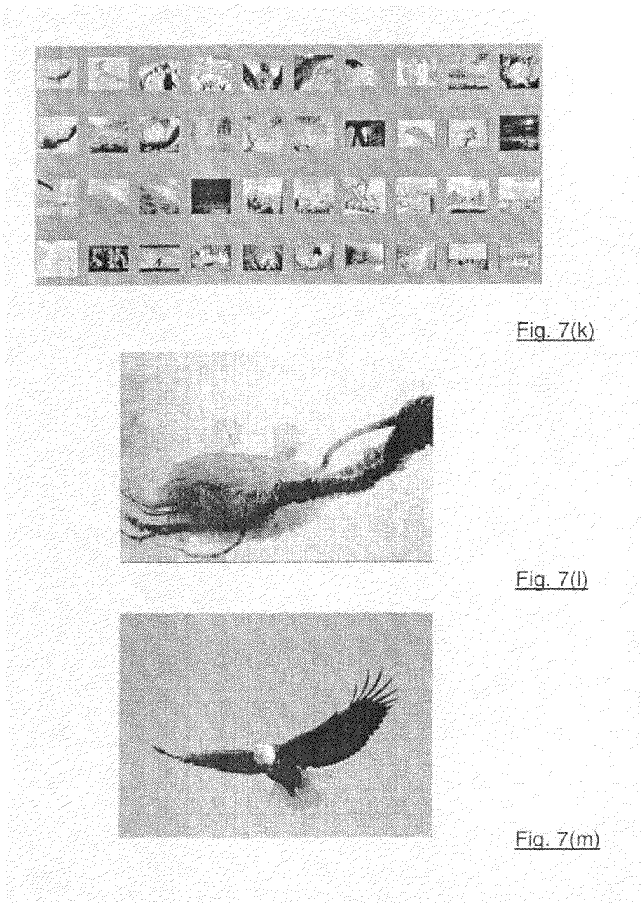

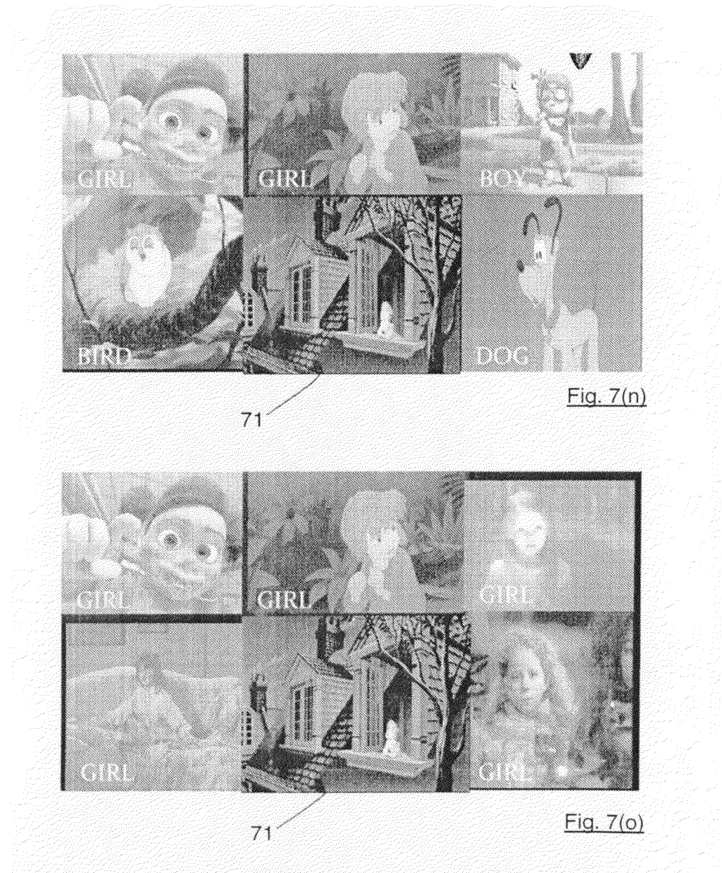

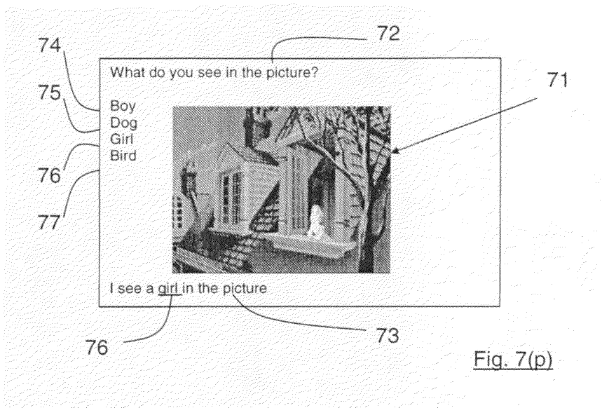

Referring to FIGS. 7(a) to 7(p), there is shown an exemplary embodiment of the invention in operation. Again, it will be understood that the example shown is targeted towards an individual having strong visual sensory skills and poor oral and aural sensory skills. Modification of the steps undertaken and the order of the steps undertaken may be varied depending on the clinical condition of the human subject.

Referring to FIG. 7(a) there is shown a stimulus image 71. The stimulus image 71 has been taken from a video containing that stimulus image. The stimulus image and the video from which the stimulus image is taken are chosen to relate to a concept that must be taught. In this case, the concept is “girl”. The still image contains a picture of a girl. After the human subject is shown a video containing the concept to be taught, which in this case is a clip from the animated feature Peter Pan, the still image of the concept to be taught is presented on a visual display to the human subject along with a query 72 and an incomplete response 73 and a number of text words 74, 75, 76, 77 for insertion into the incomplete response 73. One of the words 74, 75, 76, 77 is descriptive of the concept, in this case word 76 “girl”, whereas the remaining words 74, 75 and 77 are decoy words, “boy”, “dog” and “bird”. The decoy words or foil words as they are also known are non-descriptive of the concept, “girl”.

If the human subject wishes to answer the query 72 immediately by completing the incomplete answer 73 they may do so. Alternatively, they may wish to explore the word options 74, 75, 76, 77 to see whether they are relevant to the correct answer. For example, if the human subject selects the word “boy” 74 from the list of available answers for review, a library of still images relating to the concept of “boy” are retrieved and displayed to the human subject as shown in FIG. 7(c). The human subject may select one or more of those images for individual inspection and examine them as shown in FIG. 7(d). If desired, the human subject may choose to compare those images with the still image 71 which is demonstrative of the concept taken from the video clip as shown in FIG. 7(e). Likewise, the human subject can select the word “dog” 75 and a library of still images will be retrieved relating to the concept “dog” as shown in FIG. 7(f). The human subject can select one or more of the images for individual display on the screen as shown in FIG. 7(g).

If the human subject selects the word “girl” for further review a library of still images relating to the concept of “girl” will be presented to the human subject as shown in FIG. 7(h). Once again, the human subject may select individual images from that library of images for review as shown in FIGS. 7(i) and 7(j). If the human subject selects the word “bird” 77 for further review, a library of images relating to the concept of the word “bird” will be displayed to the individual as shown in FIG. 7(k) and then the human subject may select one or more of those images to review them in more detail as shown in FIGS. 7(l) and 7(m).

Once the human subject has reviewed the images associated with the various word selections, they may review the initial target still image 71 with a plurality of images demonstrative of the concepts relating to each of the words 74, 75, 76, 77 at the same time as shown in FIG. 7(n). Similarly, the human subject may compare the target image 71 with a plurality of images from the library of any single word and in the case shown in FIG. 7(o), the images all relate to the word “girl” 76, and a number of images of girls are presented on the screen along with the target image 71. Once the human subject has gone through the various options and has determined that the word “girl” is the concept being taught and that the images in the library of the word “girl” are similar in characteristics to the target image 71, the individual can answer the question by placing the word “girl” 76 into the answer 73. This can be done by either typing in the word using a keyboard, touchpad, or like device, by using some other technique such as a drag and drop technique, by “clicking” on the word 76 in the list, by selecting the word 76 in some other way such as by using arrow keys on a keyboard to scroll through the list of words 74, 75, 76, 77 and pressing a key such as the “enter” key on a keyboard when the desired word selection has been highlighted. If the subject gets the answer correct, the method moves on to another word or progresses to the next stage. If the subject gets the word wrong, the subject is asked to try again.

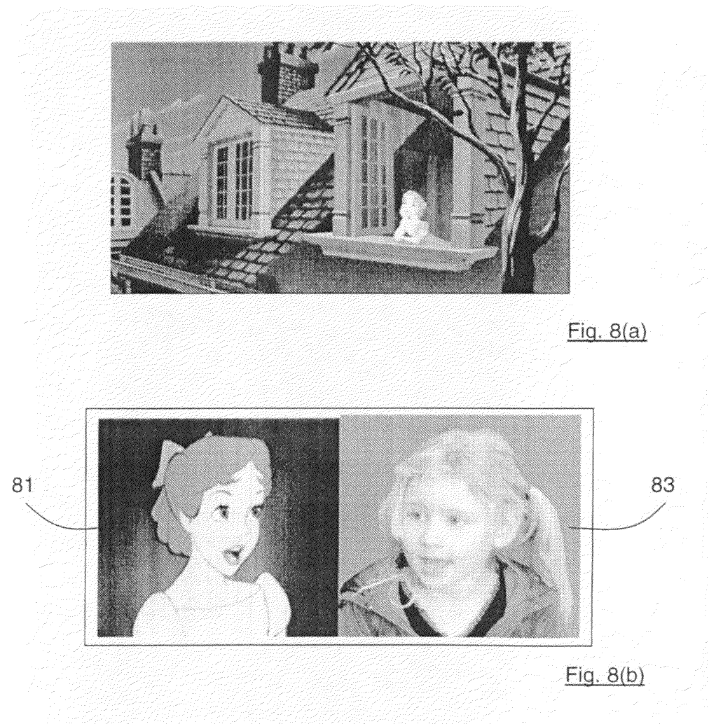

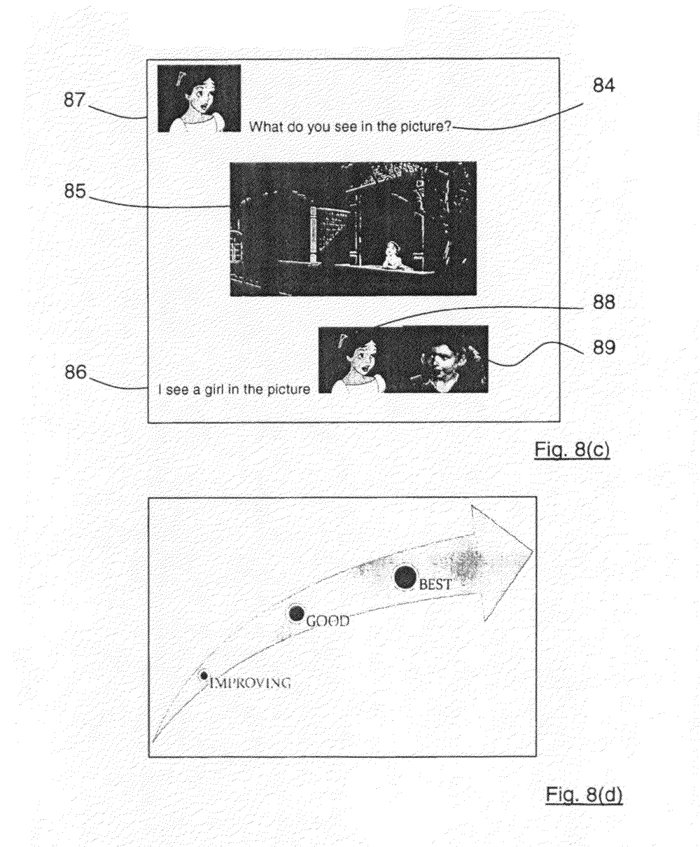

Referring to FIGS. 8(a) to 8(d), there is shown operation of the sub-component 20 in greater detail. This sub-component 20 is directed towards developing oral expression from text. In FIG. 8(a), an initial stimulus image is presented. Again, this is a scene taken from the animated feature film “Peter Pan” (copyright of Walt Disney Studios) but it could equally well be any other animated or video feature. What is important is that a familiar character is presented to the human subject, to keep the human subject engaged in the process.

In FIG. 8(b), the subject watches the character 81 say a particular word and then attempts to emulate the oral facial movements of the character 81. At the same time, a video image of the human subject 83 is captured and displayed on the visual display, preferably alongside the character 81. In this way, the subject can watch themselves attempting to emulate the oral facial movements of the character 81. In this case, the stimulus is text with supplementary auditory feedback from speech. A phonetic reading system could be employed such as the Northampton Symbol Set or similar to facilitate the pronunciation by the human subject.

Referring to FIG. 8(c), a question 84 can be posed to the human subject relating to the still image 85. A response 86 is provided and the human subject attempts to recite the response 86 as shown. This facilitates comprehension of the human subject of the concept shown in the image, as well as the words in the question and the response. These tasks are based on the premise that accurate speech production is critical for initiating effective receptive hearing and resolving auditory processing disorders. The question 84 is shown accompanied by an image 87 which is preferably a video clip of the character asking the question 84. In this way, the subject will be able to view the character asking them the question as well as reading the question. Similarly, the subject may be able to hear the question 84 being asked by playing the video clip.

In addition to the above, it can be seen that the response 86 is accompanied by a pair of images 88, 89. Image 88 is preferably a video clip of the character reciting the correct response. This can be played with or without audio and can be played automatically if desired or may be played only if the subject so requests, by for example, clicking on the image 88. The image 89 is a video image of the subject taken using a video camera such as a web camera (“webcam”) as they attempt to answer the question. This is useful for two reasons. First of all, the subject can see themselves on the screen answering the question. They can compare their answer, and in particular their oral muscle movements, with those of the character in the image 88. If desired, the two images may be played simultaneously or sequentially and a recording of the subjects answer image 89 may be taken for them or others to subsequently analyze the answer by comparison with the character answer shown in image 88. The second reason as to why the implementation shown is advantageous is that the provision of an image bearing the subject 89 is a clear indication to them that this is the time for them to provide input and answer the question.

The question 84, the still image 85 and the response 86 are all shown in the same screen however it will be understood that the question 84, image 85 and response may all be provided sequentially in their own screens or indeed it may be advantageous to play the question 84 in its own screen, followed by the still image and then superimposing the response aspects including images 88, 89 onto the same screen as the still image.

In FIG. 8(d), the graphical representation of the progress of the human subject is shown. This is created by a speech recognition engine monitoring the expression of the human subject as well as monitoring the speech enunciated through the Northampton Symbol Set supports or similar phonemic awareness stage and this provides visual feedback to the subject on their progress. In other words, it is possible to monitor the motions of the human subject, compare them with the motions of the character and determine whether the expressions of the human subject closely relate to the expressions of the character and whether the human subject is sufficiently close or indeed, whether the human subject requires further improvement.

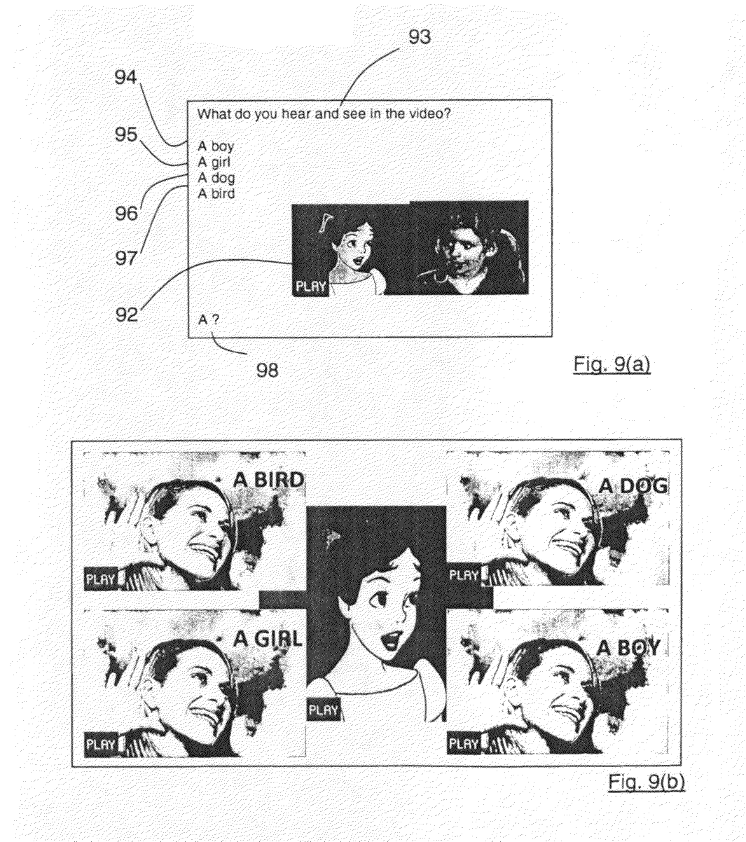

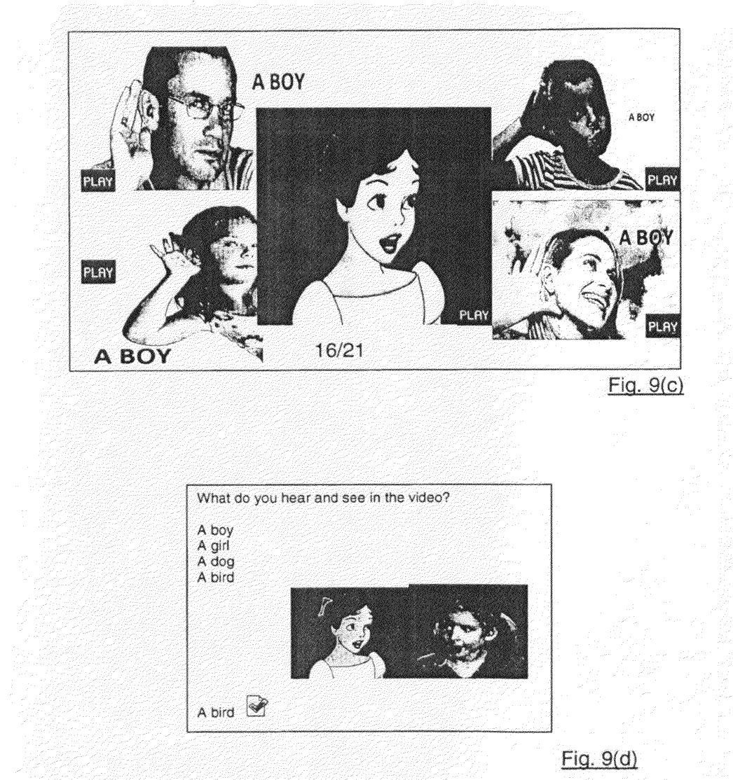

Referring to FIGS. 9(a) to 9(d) inclusive, there is shown a demonstration of the subsystem 30 which develops aural receptive language employing audio visual stimulus, such as text. Referring to FIG. 9(a), there is shown a character 92. The character 92 is presented in a video clip or similar, discussing a particular concept to be taught. A question 93 is presented relating to the audio visual stimulus delivered by the character 92. A number of word responses 94, 95, 96 and 97 are provided to the human subject. One of these word responses is the target concept, whereas the other three word responses are word decoys. In the present embodiment, the human subject listens to the stimulus video and watches the oral facial movements in order to identify what is being said. In this case, the character is discussing “a bird”, response 97. The subject is requested to provide an answer 98. This practice encourages the human subject to listen and study facial movements at the same time.

Referring to FIG. 9(b), the subject may search and listen to videos and watch oral facial movements and compare the videos to the stimulus, in order to identify the solution. In this instance, the subject is listening to one voice, which may be of a young woman, annunciating each of the four word response options 94, 95, 96 and 97. However, other alternative combinations are possible. Instead of providing a video, in certain instances it may be sufficient to have an audio file without a visual component.

Referring to FIG. 9(c), the subject may search and listen to videos and watch oral facial expressions and compare these to the stimulus video of the character 92, in order to identify the solution. In this instance, however, the subject is listening to multiple voice types, including a young man, a young boy, a young woman and a young girl, all annunciating the same word. Again, different voice/word combinations are possible. Referring to FIG. 9(d), the human subject has listened to the stimulus video and has watched the oral facial movements of the character 92 in the video, in order to identify what is being said. The human subject then either voices or types the solution or selects the solution from the list of solutions, as described before. One advantageous aspect of this sub-system 30 is that it encourages eye contact of the subject which assists in the development of language and also assists in the general pragmatics development and interaction of the subject.

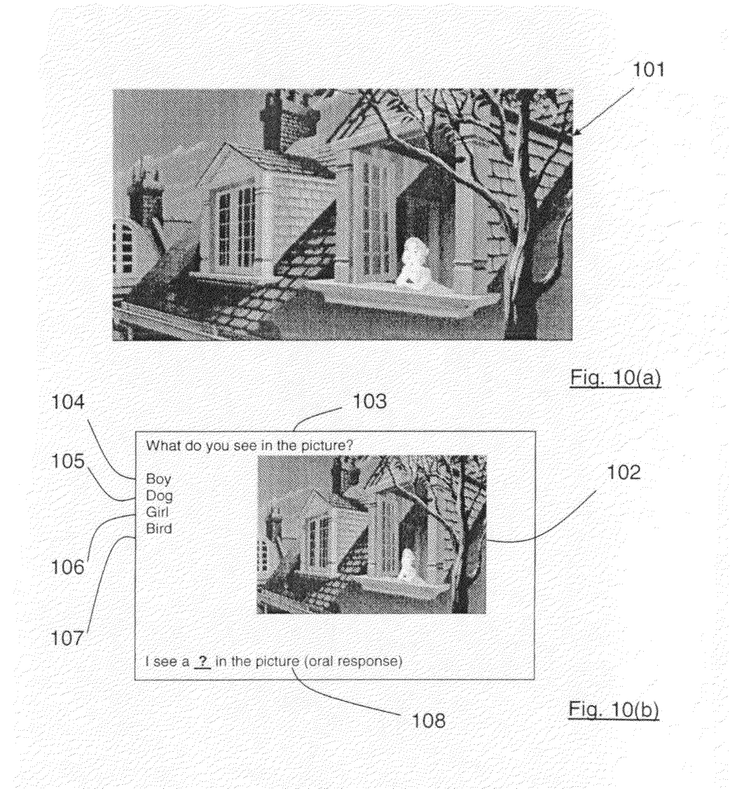

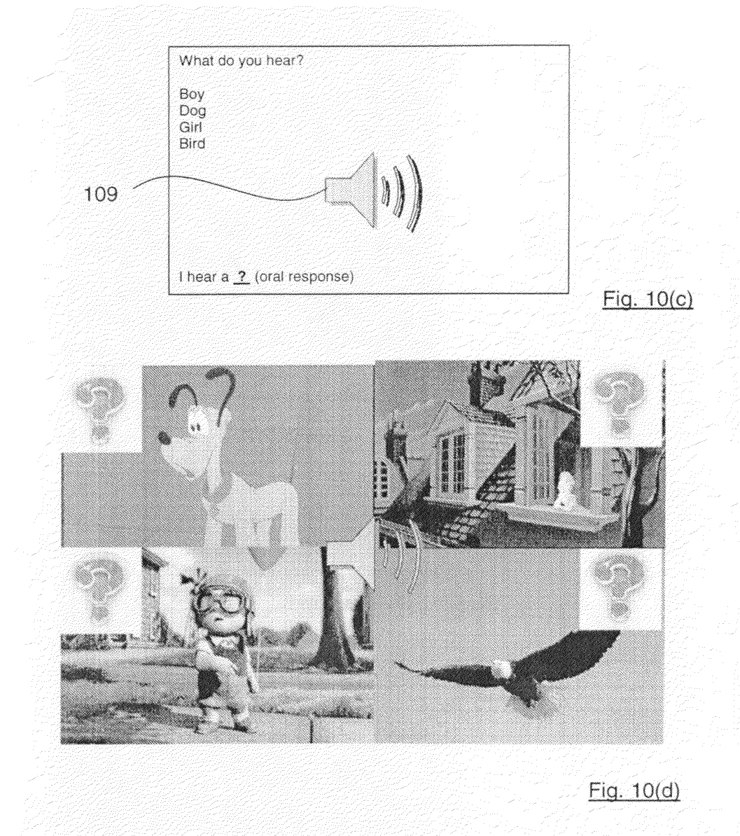

Referring now to FIGS. 10(a) to 10(d) inclusive, there is shown a plurality of screen shots relating to the sub-system component 40, in which the goal is to integrate conceptual, visual and auditory language functions. Referring to FIG. 10(a), there is shown a video clip indicated by the reference numeral 101. The video clip contains the concept to be understood and associated with language. In FIG. 10(b), a still image 102 from the video clip 101 is taken and displayed on the screen and a question 103 is presented to the human subject. A plurality of answers to the question 104, 105, 106, 107 are also presented to the user and a response 108 is suggested missing the word relating to the concept to be taught. Therefore, the human subject must choose one of the words 104, 105, 106, 107 and insert it into the response sentence 108. In this instance the system does not provide an option to search a library unless the subject makes an error or requests the feature specifically. In the implementation of FIG. 10(b), the individual is requested to provide an oral response to the query which may be analysed through an audio input device of the computer. It could however request a typed response if desired.

Referring to FIG. 10(c), there is shown an alternative embodiment in which the system provides an auditory stimulus only. A symbol 109 is shown which is a link to an audio clip that is played to a subject. The subject is provided with a question, in this case, “What do you hear?” and a number of suggested responses “Boy”, “Dog”, “Girl” and “Bird”. The subject is then requested to provide an oral response to the question. Alternatively they could provide a written response. In this embodiment, the subject associates the auditory stimulus with the written words and analyses which written word is descriptive of the auditory stimulus.

Referring to FIG. 10(d), there is shown an alternative in which the system provides auditory stimulus only and instead of providing suggested answers in the form of words, images are provided as suggested answers. In this case a number of still images, more specifically four still images, are presented and an audio stimulus is provided for example a dog barking. The human subject is then requested to select which image relates to the auditory stimulus and a response may be provided by clicking on the particular image, or by requesting the individual to say the word “dog” in this instance or by requiring the subject to type the word. This stage is more difficult than that shown in relation to FIG. 10(c). In FIG. 10(c), the answers are presented in word format so that the subject can listen to the stimulus audio and see which word applies to the audio stimulus. In the implementation in FIG. 10(d) on the other hand, only images are shown instead of words therefore requiring the subject to identify the correct image that relates to the audio file and from that image, provide the word that is descriptive of that image and the audio. In other words, additional associations are necessary in order for the subject to provide an answer. They must transition from picture to word to auditory. Importantly, the complexity may be gradually increased and the associations of the concept of sound, image and word may be embedded in the subject.

Once the above-identified steps have been completed, the system can process the responses from the previous steps and the development in conceptual, expressive and receptive language can be quantified. The system can then decide the content of the next therapy cycle, including the therapy steps in the cycle, the concepts to be taught, the associated language, the level of subtleness of computing concepts and the level of concreteness of searchable libraries. The system is programmed with artificial intelligence with features so that the method can be tailored to the specific performance of the subject. An operator may override the system if required.

It will be understood that various stages of the present invention would be carried out using a computer and therefore the invention relates to a computer implemented method and also to a computer program product having program code thereon programmed to execute the method. The computer itself could be any form of computing device having a processor, a memory, a visual display unit (VDU), an audio output unit such as a speaker, preferably an audio input unit such as a microphone and a user input device such as a keyboard, a keypad, a touch screen, a mouse or another pointing device such as a roller ball or a tracker ball that allows manipulation of a cursor on the visual display unit for selection of various options.

It will further be understood that having completed the various tasks in sequence described in FIGS. 7 to 11 inclusive, the human subject will have developed a far better understanding of language and words and will be able to build language through a series of associations going from the most concrete perception of the concept, the video or the still image through their most developed sense (vision) through to oral expression of the word, aural comprehension of the word and written comprehension of the word so that the subject can gradually build associations of the word until it forms part of their vocabulary.

The above methodology and product has been used in limited trials. These trials involved two pediatric autistic spectrum disorder (ASD) cases. These children have been exposed to computer generated stimulus employing a prototype version of the methodology and product described above over a three year time period. Prior to the inception of the test, Subject A exhibited no generalizable language with the exception of limited (approximately 10 words) use of picture exchange communication system (PECS) cards and was functionally profoundly deaf and mute. Extensive previous interventions including language pathology, total communication, various teaching strategies and medication among a raft of interventions were unsuccessful. Subsequent to the use of the methodology and product according to the invention, Subject A presented with a reading and writing vocabulary of approximately 450 words with simple sentence expression and comprehension in text. Additionally, the child had commenced oral expression of word and simple sentence approximations. Albeit limited, an emergence of single word receptive language had is also been noted.

Subject B, a less severe case to subject A, exhibited a language system approximating that of a first grade student (US School system) and was functionally severely hearing impaired with unintelligible speech. His status had remained largely unchanged over the previous two academic years. After a twelve month intervention period with the methodology and the product according to the invention, Subject B's language system approximated that typical of a fourth grade elementary student in reading and writing, and included substantially intelligible speech. Previously, other treatments had very limited effect and success with the two subjects, however dramatic improvements to their linguistic skills and communication ability have been achieved by implementing the methodologies and the product according to the invention.

Subsequent to the early invention trials described above, a second larger trial was conducted at the Magnolia Speech School in Jackson, Miss. The Magnolia Speech School has served children who are deaf, hard of hearing and/or severely speech and language disordered since 1956. The interventions conducted at this school are considered to be among the most advanced delivery of classical language development therapies within the U.S. The Magnolia School is regarded as one of the country's leading programs in moving non-verbal and low verbal children with neurologically based disorders into fluency.

In summary, the invention was applied across a cohort of children ranging in ages from 3 through 13 (N=50; 24 week duration) including a range of classically deaf and neurologically disordered subjects. Clinical diagnosis' included moderate to severe hearing impairment, autistic spectrum disorder and language based learning disabilities. Without exception the children adapted quickly and eagerly to the learning program, including children recently introduced to the use of computers.

Post induction, the children worked independently of supervision without difficulty for sustained periods while maintaining intense engagement in the learning process. Of particular note, the system's ability to teach complex socio-emotional language was unprecedented not only as compared to other available technologies but as compared to ‘standard of care’ clinical language pathology. Additionally it is clear that the conceptual and language learning process is immediate, dramatically faster and more effective than current, typically available interventions for children of this nature.

The present invention relates to a method and system that provides a means to enable children and adults with speech, reading, writing and general language based communication disabilities and/or delays to overcome their clinical issues. It is also considered that this method and system is useful in the advancement of communication among typically developing children and adults. The method and system includes provisions to expose the subject to a multi-stage process of concept development and related language learning. A primary conduit of this learning is the visual sense being combined with other functioning body senses, depending on the specific clinical case. The premise is that the most optimally functioning sense among many language learning disabled (LLD) and learning disabled (LD) children and adults is the visual sense and associated cognitive function which can be developed and organized to support the development of the visual and ultimately auditory language systems. The purpose of the method and system is to create an effective communication channel through which the prevailing cognitive function, typically visual, can be developed and organized. Once this cognitive function is engaged in a therapeutic process, it has been found that other cognitive functions such as auditory functions can be established and anchored into the primary cognitive engine.

The nature, structure, sequence and content of the method and system has been developed to achieve the described objectives and has been demonstrated to provide extraordinary results in limited clinical studies. In providing uniquely structured and sequenced stimuli to the patient, the method and system functions to engage the subject, integrate concept development with visual and aural language development in a manner that promotes the development of both specific and generalized language. Additionally, the disclosure includes a method and system to be distilled into computer software to be executed on various hardware platforms including personal computers and gaming technologies currently available. The combined method and system has been shown to positively modify patient reading, writing, speech and listening skills. This has been further enhanced through the use of audio, visually rich animated characters typical of those seen in Disney®, Pixar®, and Lucas® studio output.

Furthermore, the disclosure includes a method and system to establish an evolving capacity for concept development and associated language including visual, aural and oral modalities. This leads to a broadly based improvement in the conceptual understanding of the patient's environment and multi-modal language acquisition and development. The invention further relates to the definition of a novel approach to development of speech and language in patient populations presenting with delayed or disordered language. These patient populations will include, but not be limited to hearing impaired, auditory processing disorders, semantic and syntactic language disorder, aural motor planning disorders, apraxia and aphasia. Patient populations with spectrum conditions such as pervasive developmental disorder and autism response to the therapeutic paradigm described herein.

Additionally, the application of this novel approach will provide accelerated language learning for developmentally delayed or typically developing or developed subjects interested in improving their language acquisition capability and skills. Recent studies have shown that communicatively delayed or disordered patients frequently possess average or above average visual reasoning competencies which can be harnessed to acquire language. However, this patient population is frequently unable to benefit from these competencies given the existence of developmental delays or disorders outside of the visual cognitive function. As an example, a hearing impaired auditory processing disordered child often present with co-existing strengths in visual competencies. The nature of this invention establishes and exploits areas of strength, structures and organizes these strengths to provide for the acquisition of language initially through the stronger visual mediums.

The therapeutic paradigm associated with the invention establishes and adapts to the subjects strengths, typically visual and develops these strengths towards the establishment of a generalized language system to which other modalities of language may be associated. The method and system paradigm is predicated on the functional requirement that the subject is provided with a clear and discreet understanding of the concept of which language is to be attached. Through the use of virtual reality, interactive video games, or computer generated imagery (CGI) specific concepts are isolated and exposed to the subject. These concepts are further isolated into still pictures which when manipulated with stimuli text establish language categories, category contents and fundamental meaning to be associated with the target text stimulus. The process moves to the specific, to the general and back to the specific, thus evolving a standardized, generalized and sequential language system applicable to and directly related to the subject's environment.

Embedded into this process is the integration of text based visual symbols, (such as words) to auditory information. This process of establishing connections between auditory stimulus and visual symbology is manipulated employing all motor exercises to create or develop oral reading and expressive skills. As these skills are established, the subject is exposed to auditory stimuli which are associated with visual language such as texted words. The process segment develops receptive language competency, thus completing the therapeutic cycle moving from the establishment of generalized visual (reading and writing) to auditory language competencies.

The method and system is initially composed of an overarching meta system (1) which embodies the combined therapeutic interventions which are executed as a language development cycle. This high level system encompasses several sub-systems (10, 20, 30, 40, 50) and interrelated processes. The overall methodology and system is as depicted in FIG. 1 providing an intervention suitable to subjects presenting with multiple disabilities including but not limited to hearing impairment, auditory processing disorder, pragmatic, semantic and syntactic language disorders and aural motor planning issues. Depending on the presenting clinical state of the patient, several variations of the sequence, content, intensity and repetition associated with the meta system and/or sub-systems is possible as dictated by differential analysis of the patient's condition and therapeutic needs. This assessment can be provided by an appropriate practitioner or by assessment completed by the method and system software. Considerable use of decision tree analysis is embedded in the method and system software employing artificial intelligence principles. Additionally the method and system software will be adaptable to be executed on several hardware platforms including personal computers, or gaming systems such as Nintendo Wii, or DS Lite® with the software architecture specifically adapted to the hardware configuration, user interface and operating system.

The present invention therefore provides a method to isolate and present discrete environmental concepts in audio visual formats, employing technologies such as computer generated imagery or virtual reality. It further provides a method to subdivide concept stimulus into still pictures and to pair these still pictures with language text, whereby the text will be simultaneously paired with one correct picture and several foils. The patient will employ text stimuli to search and find associated pictorial language categories within a digital library. This library encompasses language categories which are constructed employing specific through abstract images associated with the target text. These language category libraries exist in multiple modalities including visual and auditory language representations.

The invention further relates to a method to train the patient to develop an auditory awareness and correlation of sound to visual imagery (including pure tone through consonant and vowel blend stimuli) with providing the basis of aural reading skills with or without the support of a typically functioning aural receptive language capability. It further aims to stimulate the blending of all speech sounds through exposure to visual stimuli demonstrating progressively increasingly complex oral speech motor planning. This employs oral to visual feedback loops and algorithms, thus controlling and optimizing the learning process specifically to individual patient needs. The method further stimulates aural receptive language through the exposure of the patient auditory language stimulus which is subsequently compared to texted words including a target word reflecting the stimulus and several foils. The auditory stimuli are manipulated to match the patient's auditory capability based on data collected during earlier stages of patient therapy.

Furthermore, the method provides for a patient employing the text presented to search and find in auditory language library reflecting the word/language category which is constructed from precise to less precise auditory reproduction, thus challenging the patient to further build conceptual and categorical understanding of the auditory stimuli presented. The method also provides language therapy, tested as an integrated unit identifying relative strengths and weaknesses in the patient, thus defining next stage interventions employing the method and system.

It will be further understood that the method according to the present invention will be performed largely in software and therefore the present invention extends also to computer programs, on or in a carrier, comprising program instructions for causing a computer to carry out the method. The computer program may be in source code format, object code format or a format intermediate source code and object code. The computer program may be stored on or in a carrier including any computer readable medium, including but not limited to a floppy disc, a CD, a DVD, a memory stick, a tape, a RAM, a ROM, a PROM, an EPROM, a hardware circuit or a transmissible carrier such as a carrier signal when transmitted either wirelessly and/or through wire and/or cable. The term computer will be understood to encompass a broad range of computing devices used by individuals to run an enterprise planning tool including but not limited exclusively to a personal computer (PC), a laptop, a netbook, a personal digital assistant, a handheld device such as a mobile phone, Blackberry® or other mobile computing device.

Those skilled in the art will appreciate that various adaptations and modifications of the just described preferred embodiments can be configured without departing from the scope and spirit of the invention. Therefore, it is to be understood that, within the scope of the appended claims, the invention may be practiced other than as specifically described herein.

What is claimed is:

1. A computer implemented method of developing concepts and related language in the form of literacy and auditory speech and/or hearing in learning disabled human subjects, the computer comprising a processor, a memory, a visual display unit (VDU), an audio output device, an audio input device and a user input device, the method comprising the steps of:
selecting a concept to teach to the human subject;
displaying a video clip demonstrative of the concept to the subject on the VDU;
displaying a still image demonstrative of the concept taken from the video clip to the subject on the VDU;
displaying a plurality of words along with the still image to the subject on the VDU, one of the words being descriptive of the concept demonstrated by the still image and one or more words being a decoy word that is non-descriptive of the concept;
for each of the words, providing a library of word images in memory that are demonstrative of the word;
retrieving one or more word images from the library and displaying the one or more retrieved word images on the VDU upon request by the human subject for comparison with the still image; and
receiving an input from the human subject pairing one of the words with the still image.

2. The computer implemented method of claim 1 comprising the additional step of providing a video clip of the word that is descriptive of the concept being taught, the video clip of the word comprising a visual demonstration of the word being orally expressed.

3. The computer implemented method of claim 2 comprising the additional steps of:
capturing a video of the human subject attempting to emulate the oral expressions in the visual demonstration of the word being orally expressed; and playing back the video of the human subject attempting to emulate the oral expressions on the VDU.

4. The computer implemented method of claim 3 in which the video of the human subject attempting to emulate the oral expressions is played back on the VDU coincidentally with the video clip of the word being orally expressed.

5. The computer implemented method of claim 1 comprising the additional steps of:
displaying a video of a word that is descriptive of the concept being taught, the video of the word comprising a visual demonstration of the word being orally expressed:
displaying a plurality of word selections in text, one of which is the word being spoken and the other being a decoy word; and
receiving an input from the human subject pairing one of the text words with the video of the word being orally expressed.

6. The computer implemented method of claim 5 comprising the steps of:
for each of the word selections in text, providing a library of videos with audio content in memory that are demonstrative of the word;
retrieving one or more videos with audio content from the library and displaying the one or more retrieved videos on the VDU upon request by the human subject for comparison with the video of the word being orally expressed.

7. The computer implemented method of claim 6 in which the library of videos comprise a single character expressing words corresponding to the selection of words provided.

8. The computer implemented method of claim 6 in which the library of videos comprise a plurality of characters expressing each of the word selections.

9. The computer implemented method of claim 1 comprising the steps of:
displaying a still image demonstrative of the concept to be taught to the subject on the VDU;
displaying a plurality of words along with the still image to the subject on the VDU, one of the words being descriptive of the concept demonstrated by the still image and one or more words being a decoy word that is non-descriptive of the concept; and
receiving an oral response from the human subject matching one of the displayed words to the still image.

10. The computer implemented method of claim 1 comprising the additional steps of:
playing a stimulus audio file:
providing a plurality of still images, each having an audio file associated therewith, one of which corresponds to the stimulus audio file; and
receiving an input from the human subject pairing one of the still images and its corresponding audio file with the stimulus audio file.

11. The computer implemented method of claim 10 in which the step of playing a stimulus audio file comprises playing a soundtrack.

12. The computer implemented method as claimed in claim 10 in which the step of playing a stimulus audio file comprises playing a tone.

13. The computer implemented method of claim 10 in which the step of playing a stimulus audio file comprises playing an auditory complex.

14. A computer implemented method of claim 13 in which the step of playing an auditory complex comprises playing a phonemic or other word building block sound.

15. The computer implemented method of claim 1 in which the library of word images comprise still images.

16. The computer implemented method of claim 1 in which the library of word images comprise video clips.

17. A computer program product comprising a computer readable medium having computer readable program code embodied therein, said computer program code adapted to be executed on a computer processor to implement a method of developing language and speech in learning disabled human subjects, the computer program code comprising:
computer program code for selecting a concept to teach to the human subject;
computer program code for displaying a video clip demonstrative of the concept to the subject;
computer program code for displaying a still image demonstrative of the concept taken from the video clip to the subject;
computer program code for displaying a plurality of words along with the still image to the subject, one of the words being descriptive of the concept demonstrated by the still image and one or more words being a decoy word that is non-descriptive of the concept;
computer program code, for each of the words, providing a library of word images that are demonstrative of the word;
computer program code for retrieving one or more word images from the library and displaying the one or more retrieved word images upon request by the human subject for comparison with the still image; and
computer program code for receiving an input from the human subject pairing one of the words with the still image.

18. The computer program product of claim 17 further comprising computer code for providing a video clip of the word that is descriptive of the concept being taught, the video clip of the word comprising a visual demonstration of the word being orally expressed.

19. The computer program product of claim 18 further comprising computer code for capturing a video of the human subject attempting to emulate the oral expressions in the visual demonstration of the word being orally expressed; and for playing back the video of the human subject attempting to emulate the oral expressions.

20. The computer program product of claim 19 in which the video of the human subject attempting to emulate the oral expressions is played back coincidentally with the video clip of the word being orally expressed.

21. The computer program product of claim 20 further comprising:
computer code for displaying a video of a word that is descriptive of the concept being taught, the video of the word comprising a visual demonstration of the word being orally expressed;
computer code for displaying a plurality of word selections in text, one of which is the word being spoken and the other being a decoy word; and
computer code for receiving an input from the human subject pairing one of the text words with the video of the word being orally expressed.

22. The computer program product of claim 21 further comprising:
computer program code, for each of the word selections in text, for providing a library of videos with audio content that are demonstrative of the word; and
computer program code for retrieving one or more videos with audio content from the library and displaying the one or more retrieved videos upon request by the human subject for comparison with the video of the word being orally expressed.

23. The computer program product of claim 22 in which the library of videos comprise a single character expressing words corresponding to the selection of words provided.

24. The computer program product of claim 22 in which the library of videos comprise a plurality of characters expressing each of the word selections.

25. The computer program product of claim 24 further comprising:
computer program code for displaying a still image demonstrative of the concept to be taught to the subject;
computer program code for displaying a plurality of words along with the still image to the subject, one of the words being descriptive of the concept demonstrated by the still image and one or more words being a decoy word that is non-descriptive of the concept;
computer program code for receiving an oral response from the human subject matching one of the displayed words to the still image.

26. The computer program product of claim 25 further comprising:
computer code for playing a stimulus audio file;
computer code for providing a plurality of still images, each having an audio file associated therewith, one of which corresponds to the stimulus audio file; and
computer code for receiving an input from the human subject pairing one of the still images and its corresponding audio file with the stimulus audio file.

27. The computer program product of claim 26 in which the playing of a stimulus audio file comprises playing a soundtrack.

28. The computer program product of claim 26 in which the playing of a stimulus audio file comprises playing a tone.

29. The computer program product of claim 26 in which the playing of a stimulus audio file comprises playing an auditory complex.

30. The computer program product of claim 29 in which the playing of an auditory complex comprises playing a phonemic or other word building block sound.

31. The computer program product of claim 30 in which the library of word images comprise still images.

32. The computer program product of claim 31 in which the library of word images comprise video clips.

33. A computer implemented method of developing language and speech in language learning disabled and generally learning disabled human subjects comprising the steps of:
providing a representation of the concept to be taught in a first format on a video screen;
providing a plurality of representations in a second format on the video screen, one of the which being an alternative representation of the concept to be taught; and
requesting the human subject to determine an association between the representation in the first format of the concept to be taught and the alternative representation in the second format of the concept to be taught; and
receiving an input from the human subject based on the determination.

34. The computer implemented method of claim 33 in which the human subject determines the association between the representation of the concept to be taught in the first format and the second format by:
accessing a library of representations on a computer associated with the representation in the second format, the library containing a plurality of representations in the first format;
comparing the representations in the first format in the library with the representation of the concept in the first format;
determining whether the representations in the library are equivalent to the representation of the concept in the first format and thereby determining an association between the representation of the concept to be taught in the first format and the second format.

35. The computer implemented method of claim 34 in which the representation of the concept to be taught in a first format is provided in a still image format.

36. The computer implemented method of claim 34 in which the representation of the concept to be taught in a first format is provided in a video format.

37. The computer implemented method of claim 34 in which the representation of the concept to be taught in a first format is provided in an audio format.

38. The computer implemented method of claim 37 in which the representation in the second format is provided in a text word format.

39. The computer implemented method of claim 37 in which the representation in the second format is provided in a still image format.

40. The computer implemented method of claim 39 in which a series of representations of the concept to be taught are provided in a plurality of different formats and the human subject forms associations with the series of representations of the concept to be taught.

41. The computer implemented method of claim 40 in which the series of representations of the concept to be taught become gradually more abstract, the first representation in the series being the most concrete representation of the concept to be taught and the last representation in the series being the most abstract.

42. The computer implemented method of claim 41 in which the first representation in the series is (i) a video representation, which graduates in sequence to one or more of (ii) a pictorial representation; (iii) a text word representation; (iv) an oral language production representation; and (v) a receptive spoken language representation.
